(19) United States
(12) Patent Application Publication
(10) Pub. No.: US 2007/0209413 A1
(43) Pub. Date: Sep. 13, 2007

(54) Lock manual override mechanism with deadlatch

(75) Inventor: Glen L. Dobbs, Woodbury, CT (US)

Correspondence Address: MICHAEL BEST & FRIEDRICH, LLP, 100 E WISCONSIN AVENUE, Suite 3300, MILWAUKEE, WI, 53202, US

(73) Assignee: Schlage Lock Company, Carmel, IN (US)

(21) Appl. No.: 11/717,358

(22) Filed: Mar. 13, 2007

Related U.S. Application Data
(60) Provisional application No. 60/781,781, filed on Mar. 13, 2006.

(51) Int. Cl. E05B 47/00

(52) U.S. Cl. 70/279.1

(57) ABSTRACT

An override mechanism is for a lock assembly including a movable latch, a retractor for displacing the latch, first and second rotatable spindles for operating the retractor, and an electronic clutch with a movable member for releasably connecting the first and second spindles. The override mechanism includes an override member movable between an inoperative position and an operative position and configured to displace the clutch member so as to connect the first and second spindles when the override member displaces from the inoperative position toward the operative position. A deadlatch is movable between a latching position and a nonlatching position and is configured to releasably retain the override member at the inoperative position when the deadlatch is disposed at the latching position. Preferably, an actuator is configured to displace the override member between the inoperative and operative positions and to alternatively retain the deadlatch at the latching position.

### BACKGROUND OF THE INVENTION

This application claims priority to U.S. Provisional Application Ser. No. 60/781,781, filed Mar. 13, 2006, the entire contents of which are incorporated herein by reference.

The present invention relates to locksets, and more particularly to electronic-actuated locksets.

Locksets are generally known and typically include a latch or deadbolt engageable with a strike so as to “lock” or retain a door disposed within a doorframe. Certain known locksets include electronic components, such as key pad, card readers, etc., that are used to operate the mechanical components of the lockset so as to controllably displace the latch or deadbolt between locked and unlocked positions. Such mechanical components include one or more rotatable spindles which operate a mechanism or component, such as a latch bolt, directly attached to or connected with the latch.

### SUMMARY OF THE INVENTION

In one aspect, the present invention is an override mechanism for a lock assembly, the lock assembly including a movable latch, a retractor for displacing the latch, first and second rotatable spindles for operating the retractor, and an electronic clutch with a movable member for releasably connecting the first and second spindles. The override mechanism comprises an override member movable between an inoperative position and an operative position and configured to displace the clutch member so as to connect the first and second spindles when the override member displaces from the inoperative position toward the operative position. A deadlatch is movable between a latching position and a nonlatching position and is configured to releasably retain the override member at the inoperative position when the deadlatch is disposed at the latching position.

In another aspect, the present invention is again an override mechanism for a lock assembly, the lock assembly including first and second spindles and an electronic clutch with a movable member for releasably connecting the first and second spindles. The override mechanism comprises an override member movable between an inoperative position and an override position and configured to displace the clutch member so as to connect the first and second spindles when the override member displaces from the inoperative position toward the override position. A deadlatch is movable between a latching position and a nonlatching position and is configured to releasably retain the override member at the inoperative position when disposed at the latching position. Further, an actuator is configured to displace the override member between the inoperative and override positions and/or to retain the deadlatch at the latching position.

In a further aspect, the present invention is a lock assembly comprising a latch displaceable between locked and unlocked positions and a retractor configured to displace the latch between the locked and unlocked positions. A first spindle is operatively coupled with the retractor such that rotation of the first spindle displaces the latch between the locked and unlocked position. A second spindle is configured to be manually rotatable and releasably connectable with the first spindle such that rotation of the second spindle when connected with the first spindle operates the retractor. An electronic clutch includes a movable member configured to displace at least a portion of one of the first and second spindles into engagement with the other one of the first and second spindles. Further, an override member is movable between an inoperative position and an operative position and is configured to displace the clutch member so as to connect the first and second spindles when the override member displaces from the inoperative position toward the operative position. Furthermore, a deadlatch is movable between a latching position and a nonlatching position and configured to releasably retain the override member at the inoperative position when disposed at the latching position. Also, an actuator is configured to displace the override member between the inoperative and operative positions and to alternatively retain the deadlatch at the latching position.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a front perspective view of a lock system incorporating a deadlatchable override mechanism in accordance with the present invention;

FIG. 2 is a perspective view of the lock assembly and the override mechanism, shown without a housing shell and handle, with an override member in an inoperative position and a deadlatch in a latching position;

FIG. 3 is a broken-away, enlarged perspective view of the override mechanism, showing the override member in an operative position and the deadlatch in a nonlatching position;

FIG. 4 is another broken-away, enlarged perspective view of the override mechanism of FIG. 3, shown with the majority of a preferred lock actuator removed;

FIG. 5 is a partly broken-away, front elevational view of the lock assembly and override mechanism, showing the override member in the inoperative position and the deadlatch at the latching position;

FIG. 6 is another view of the lock assembly and override mechanism of FIG. 5, showing the override member at the operative position and the deadlatch at the nonlatching position;

FIG. 7 is an enlarged, broken-away front plan view of the override member and the deadlatch, showing the override member in the inoperative position and the deadlatch at the latching position;

FIG. 8 is another enlarged, broken-away front plan view of the override member and the deadlatch, showing the override member in the operative position and the deadlatch at the nonlatching position;

FIG. 9 is another view of the override member and the deadlatch of FIG. 7, showing a preferred cylinder lock actuator with the cylinder in a first position;

FIG. 10 is another view of the override member and the deadlatch of FIG. 8, showing a preferred cylinder lock actuator with the cylinder in a second position;

FIG. 11 is partly broken-away, front plan view of a lower portion of the lock assembly, showing the cylinder lock in the first position and a fastener access hole obstructed by a fastener shield;

FIG. 12 is another view of the lock assembly of FIG. 11, showing the cylinder lock in the second position and the access hole unobstructed;

FIG. 13 is a front elevational view of the override member;

FIG. 14 is a side perspective view of the override member;

FIG. 15 is a top plan view of a deadlatch body;

FIG. 16 is a front perspective view of the deadlatch body;

FIG. 17 is a rear perspective view of the deadlatch body;

FIG. 18 is a broken-away, side cross-sectional view of the lock assembly; and

FIG. 19 is a partly broken-away, rear perspective view of the lock assembly, showing a preferred retractor.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

This application involves improvements to the lock system disclosed in U.S. Pat. No. 7,007,526 of Frolov et al., which is incorporated herein in its entirety by reference thereto.

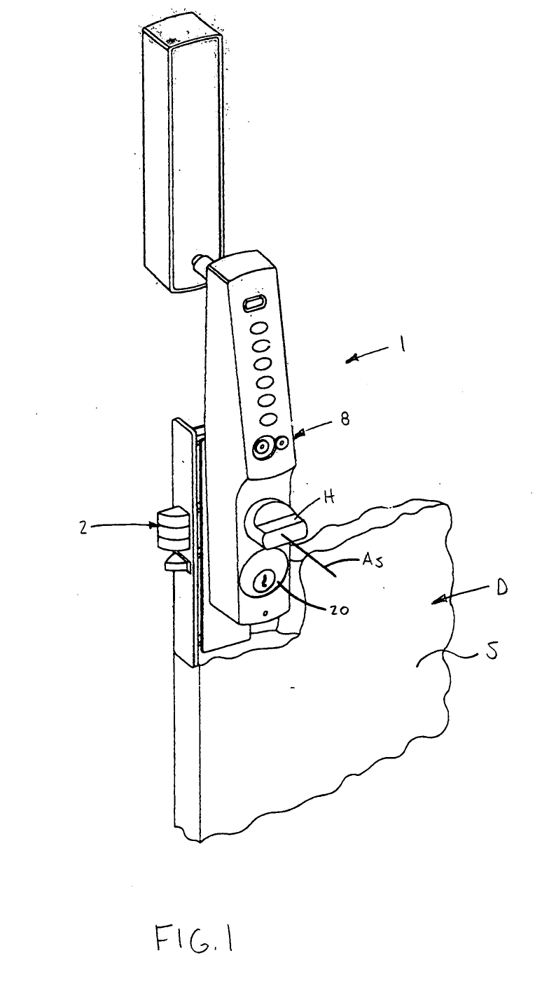

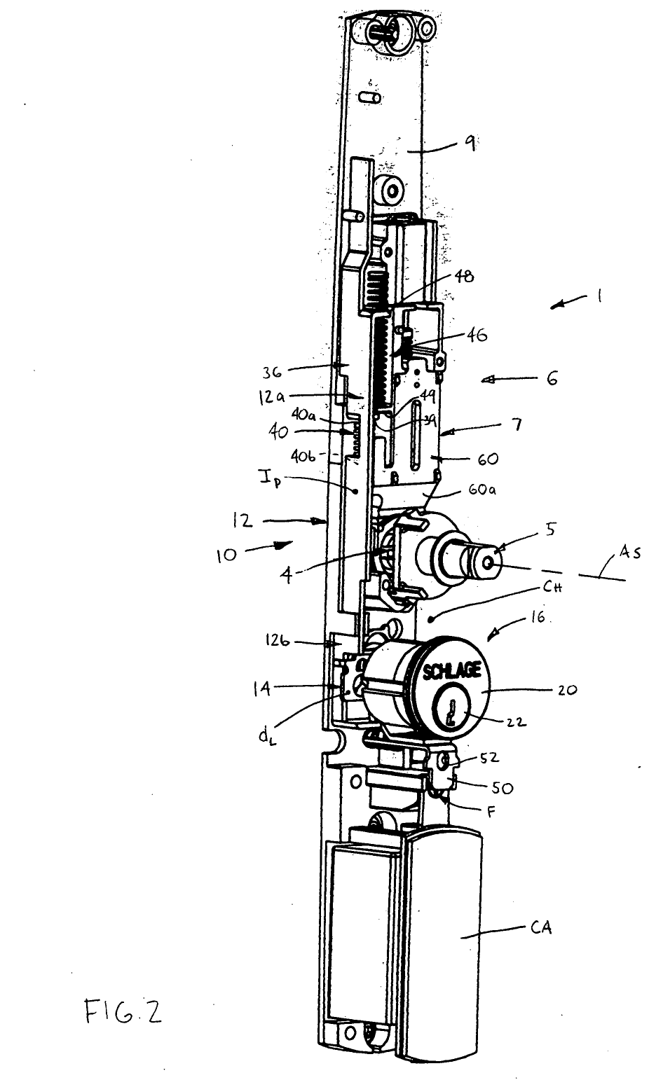

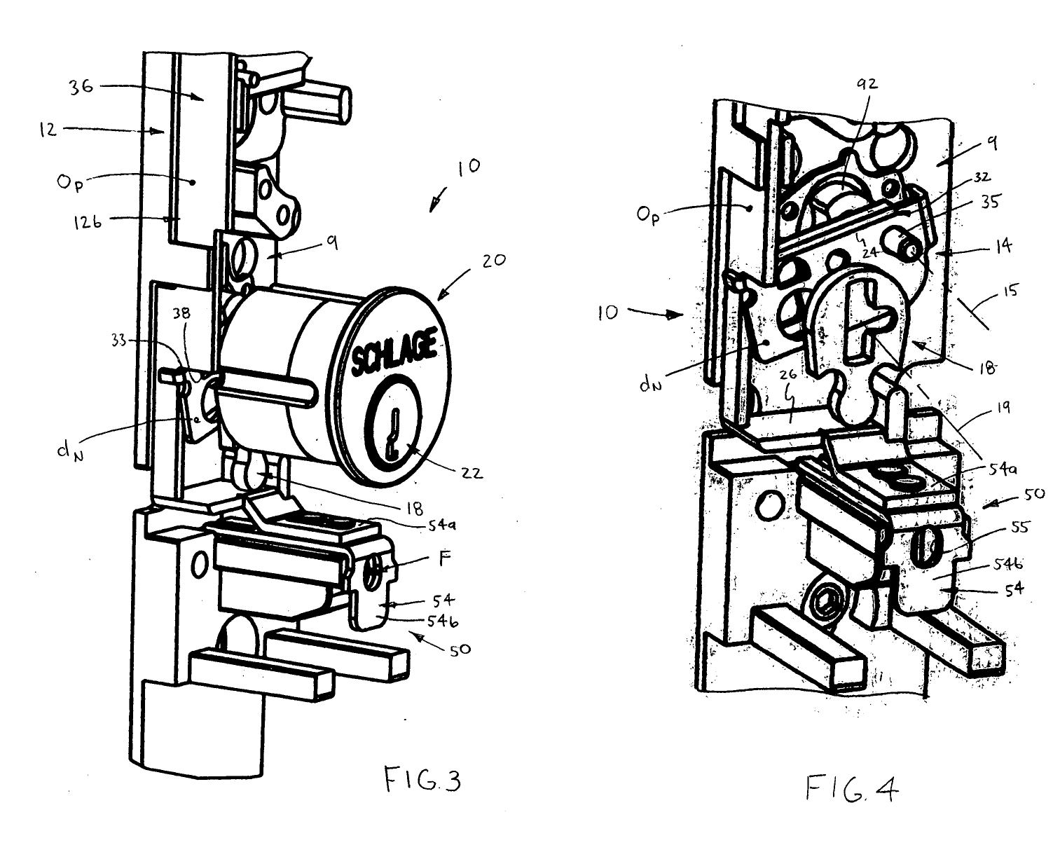

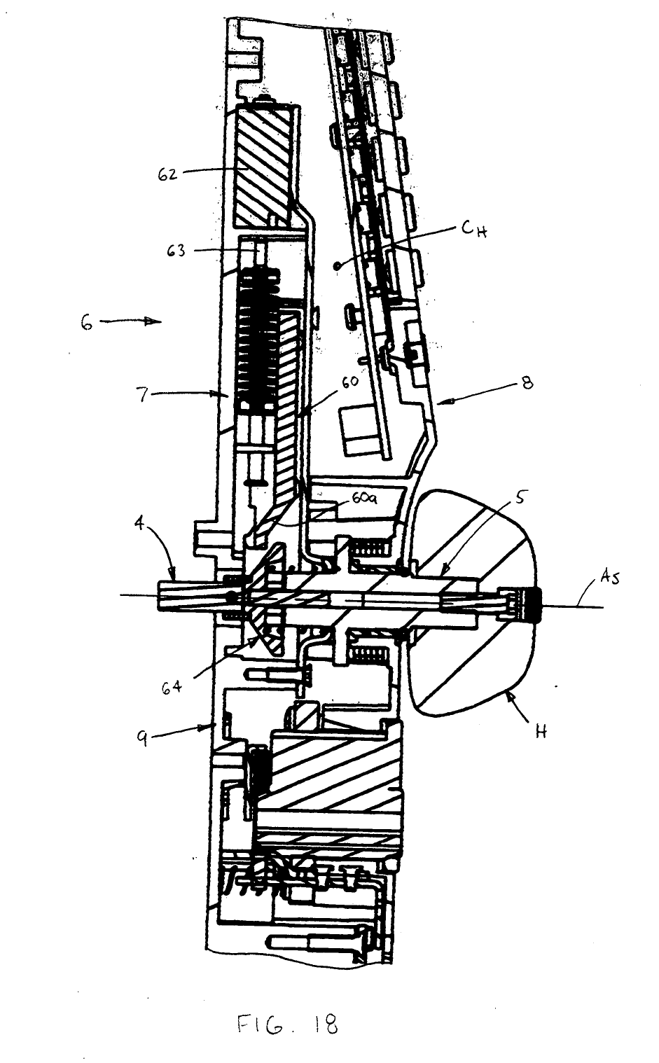

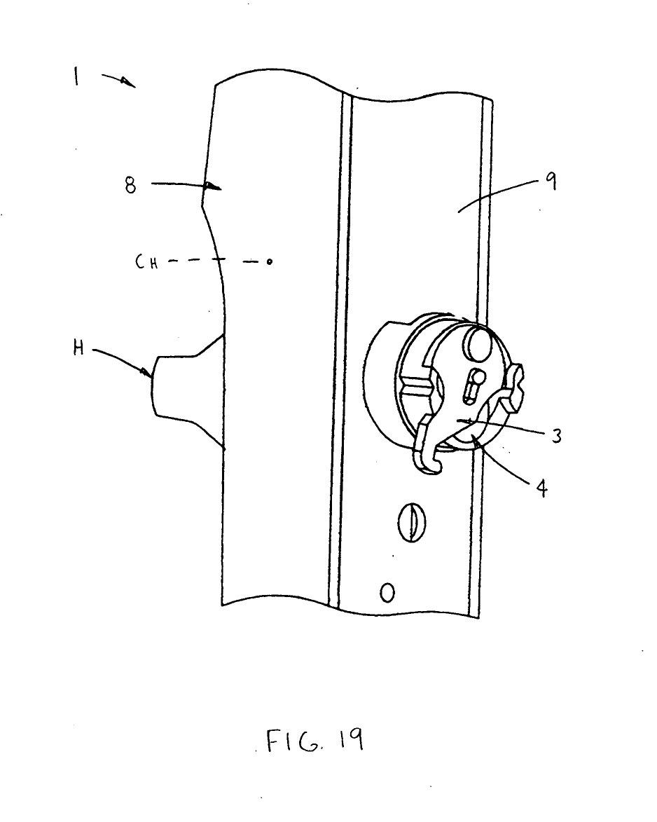

Referring now to the drawings in detail, wherein like numbers are used to indicate like elements throughout, there is shown in FIGS. 1-19 a presently preferred embodiment of a deadlatchable manual override mechanism 10 for a lock assembly 1. The lock assembly includes a movable latch 2 engageable with a strike (not shown), a retractor 3 for displacing the latch 2, first and second rotatable spindles 4, 5 for operating the retractor 3, and an electronic clutch mechanism or clutch 6 with a movable member 7 for releasably connecting the first and second spindles 4, 5. The manual override mechanism 10 basically comprises an override member 12 for displacing the clutch member 7 to couple the two lock spindles 4, 5 and a deadlatch 14 for securing or retaining the override member 12 at an inoperative position I_{P}. More specifically, the override member 12 is movable between the inoperative position I_{P} (FIGS. 2, 5, 7 and 9) and an operative position O_{P} (FIGS. 3, 4, 6, 8 and 10) and is configured to displace the clutch member 7, so as to thereby connect the first and second spindles 4, 5, when the override member 12 displaces from the inoperative position I_{P} toward the operative position O_{P}. The deadlatch 14 is movable between a latching position d_{L} (FIGS. 2, 5, 7 and 9) and a nonlatching position d_{N} (FIGS. 3, 4, 6, 8 and 10) and is configured to releasably retain the override member 12 at the inoperative position I_{P} when the deadlatch 14 is disposed at the latching position d_{L}. Thus, the deadlatch 14 basically disables (i.e., temporarily) the capability of the override member 12 to manually operate the clutch mechanism 6 and thereby operate the lock assembly 1, when the deadlatch 14 is engaged with the override member 12. As such, the deadlatch 14 functions to substantially prevent tampering to the lock assembly 1, as discussed in greater detail below.

Further, the override mechanism 10 preferably further comprises a manual actuator 16 configured to displace the override member 12 between the inoperative and operative positions I_{P}, O_{P}, and preferably also releasably retains the override member 12 at the operative position O_{P}. As such, the actuator 16 enables a user to manually unlock the lock assembly 1 and then permits the lock assembly 1 to remain in an unlocked state or configuration, as described in further detail below. Preferably, the actuator 16 is further configured to releasably retain the deadlatch 14 at the latching position d_{L}. However, another actuator (not shown) may alternatively be provided for separately operating or retaining the deadlatch 14.

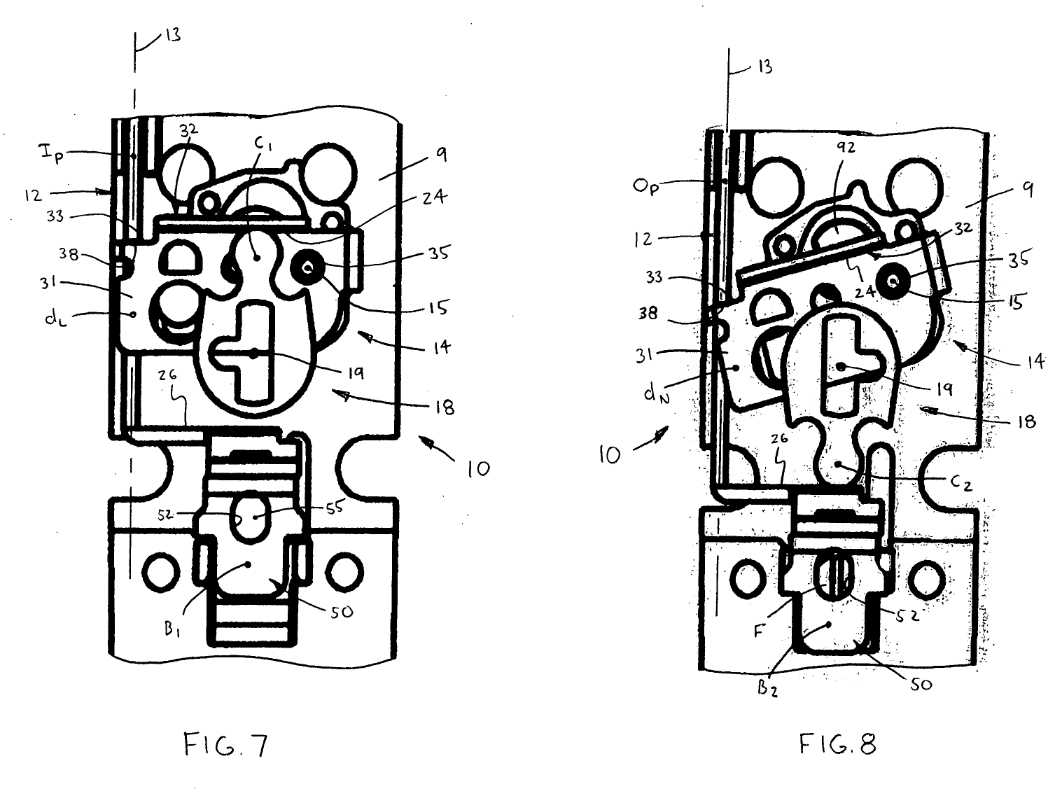

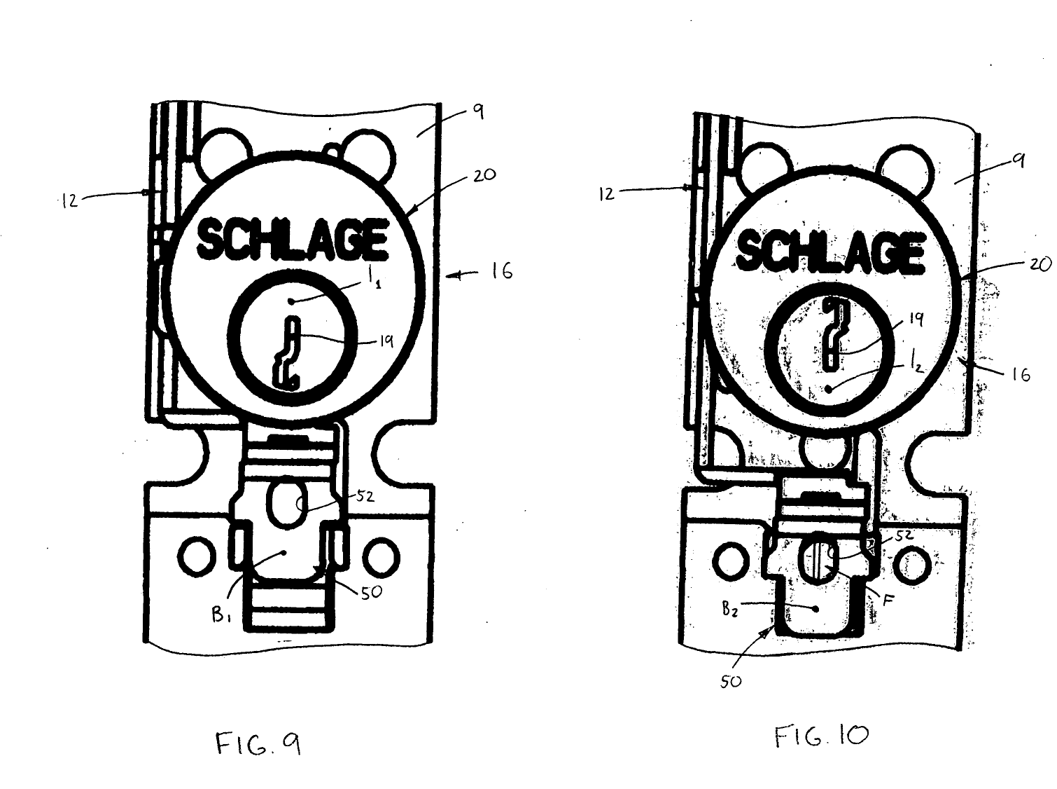

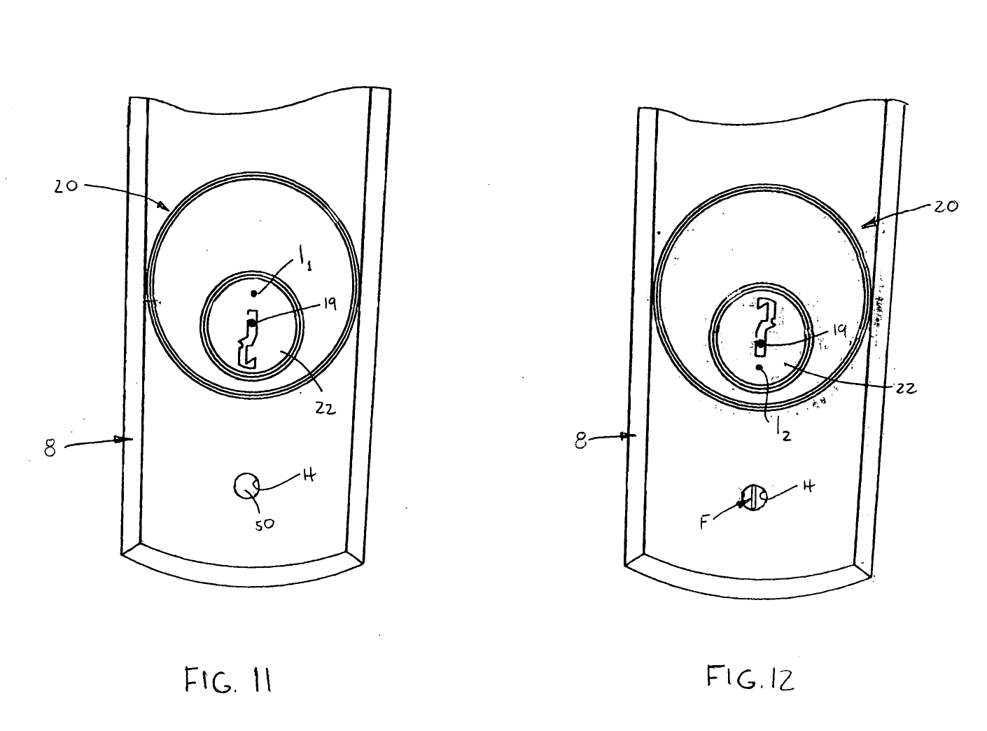

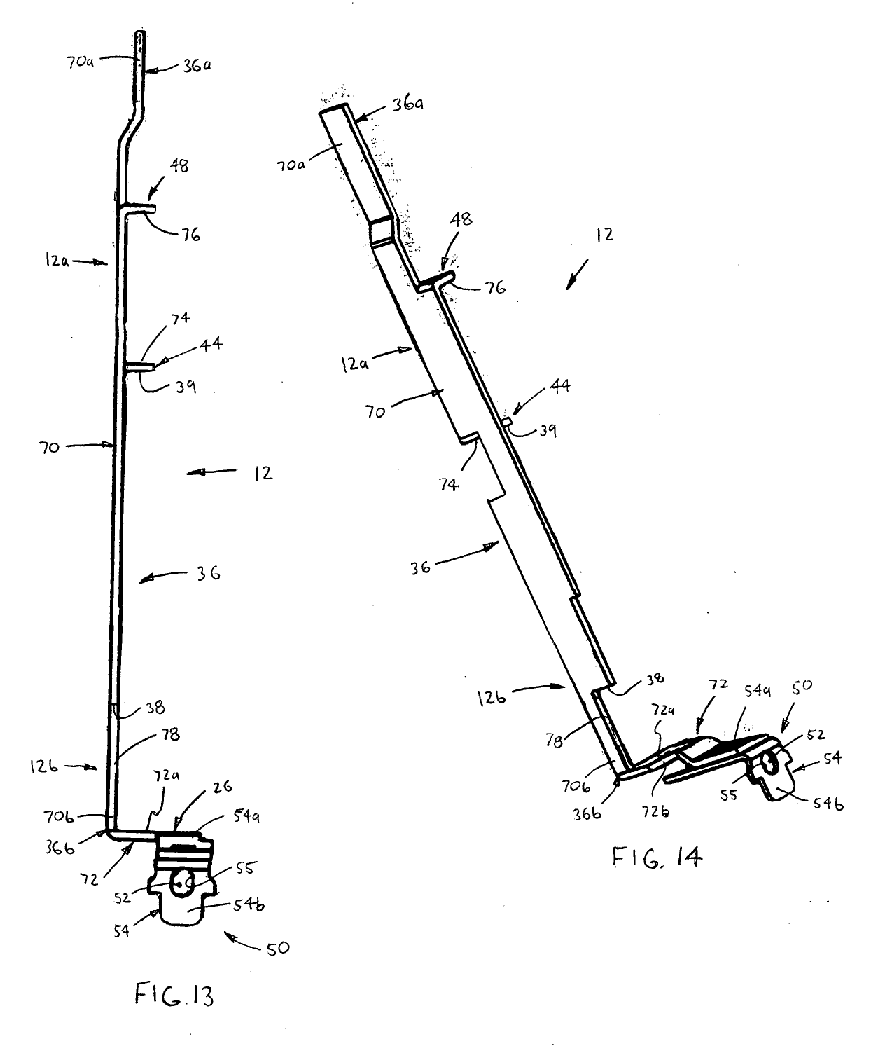

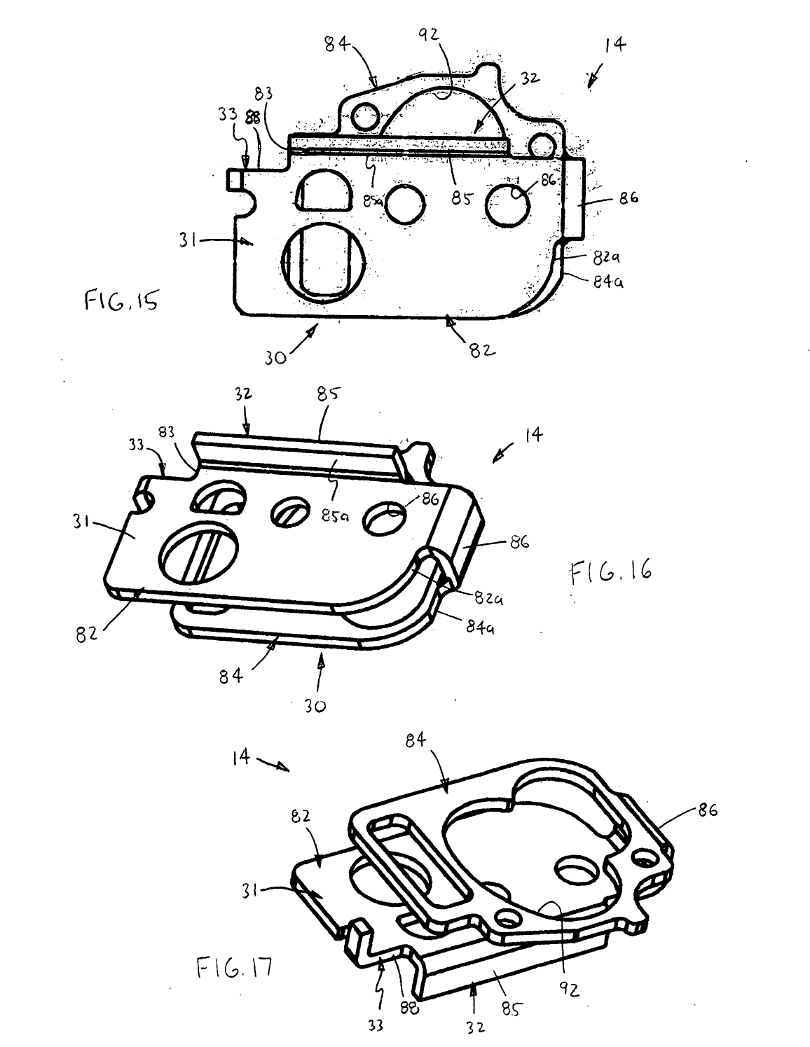

More specifically, the manual actuator 16 preferably includes a cam 18 displaceable between a first position c₁ (FIGS. 5 and 7) and a second position c₂ (FIGS. 3, 4, 6 and 8), and a lock 20 with a rotatable cylinder 22. The cam 18 is configured to retain the deadlatch 14 at the latching position d_{L} when the cam 18 is located at the cam first position c₁ and is also configured to displace the override member 12 toward the operative position O_{P} when the cam 18 displaces toward the second position c₂. Additionally, the cam 18 is operably connected with the lock cylinder 22 such that rotation of the cylinder 22 between first and second cylinder positions I₁, I₂ (see FIGS. 9-12) displaces the cam 18 between the cam first and second positions c₁, c₂. Further, the lock 20 is also preferably configured to releasably retain the override member 12 at the operative position O_{P} when the cam 18 is disposed at the cam second position c₂. That is, the lock cylinder 22 is constructed to remain at the second position I₂, for example such that the key (not shown) for operating the cylinder lock 20 may be withdrawn therefrom, until the cylinder 22 is manually rotated back to the lock first position I₁. Preferably, the cam 18 is further configured to displace the deadlatch 14 to the latching position d_{L} when the cam 18 displaces from the cam second position c₂ toward the cam first position c₁. However, the deadlatch 14 may be separately biased back toward the latching position d_{L}, such as for example, by means of a spring (not shown).

Referring to FIGS. 3-8, the deadlatch 14 preferably has a retention surface 24 and the override member 12 preferably has a drive surface 26. With this structure, the actuator cam 18 is contactable with the deadlatch retention surface 24, so as to retain the deadlatch 14 in the latching position d_{L}, when the cam 18 is disposed at the cam first position c₁. Alternatively, the cam 18 contacts and pushes against the override member drive surface 26 when the cam 18 displaces toward the cam second position c₂. Further, when the cam 18 angularly displaces from the second position c₂ to the first position c₁, the cam 18 disengages from the drive surface 26, and then contacts and pushes against the deadlatch retention surface 24 until the deadlatch 14 is located in the latching position d_{L}.

Preferably, the cam 18 is rotatable about a cam axis 19 between the cam first and second positions c₁, c₂, but may alternatively be formed so as to be linearly displaceable, or even to undergo a combination of linear and angular displacement, when moving between the two cam positions c₁, c₂. The deadlatch 14 is also preferably constructed so as to be rotatable about a deadlatch axis 15 when displacing between the latching and nonlatching positions d_{L}, d_{N}, as discussed below, the deadlatch axis 15 being preferably spaced from and extending generally parallel with the cam axis 19, but may alternatively be collinear with the cam axis 19, as discussed below.

Referring particularly to FIGS. 1, 5 and 6, the lock assembly 1 further includes a housing 8 with an interior chamber C_{H} and a base wall 9 partially bounding the chamber C_{H}, the override member 12 and the deadlatch 14 being disposed within the chamber C_{H} and the actuator 16 extending through the housing 8 so as to be partially disposed within the chamber C_{H}. More specifically, the override member 12 is slidably disposed on the base wall 9 so as to be linearly displaceable along a generally vertical axis 13 between the inoperative and operative positions I_{P} and O_{P}. Further, the deadlatch 14 is rotatably mounted to the base wall 9 such that the deadlatch axis 15 extends generally horizontally and perpendicularly to the base wall 9, and also perpendicularly to the override member axis 13.

Referring now to FIGS. 3-8 and 15-17, the deadlatch 14 preferably includes a main body 30 rotatable between the latching and nonlatching positions d_{L}, d_{N}, and is rotatably connected with the base wall 9 by a pivot shaft 35. The deadlatch body 30 preferably has an integral latching portion or arm 31 configured to engage with the override member 12 at the latching position d_{L}. Preferably, the deadlatch body 30 includes a generally rectangular rail 32 extending outwardly from the body 30 and providing the retention surface 24, and the latching arm 31 includes a generally horizontal latching surface 33 contactable with a retention surface 38 the override member 12, as described below. Although the deadlatch 14 preferably includes a body 30 rotatably mounted to the housing base wall 9, the deadlatch 14 may alternatively be directly connected with the actuator 16 so angularly displace between the latching and nonlatching positions d_{L}, d_{N} when the cam 18 displaces between the first and second cam positions c₁, c₂ (structure not shown). As a further alternative, the override mechanism 10 may be constructed with the deadlatch 14 and the actuator cam 18 being provided by a single member or body (not shown), such that the combination deadlatch/actuator cam both releasably retains the override member 12 at the inoperative position I_{P} and alternatively displaces the override member 12 to the operative position O_{P}. The scope of the present invention encompasses these and all other appropriate constructions of the deadlatch 14 and/or the cam 18 that enable the override mechanism 10 to function generally as described herein.

Referring to FIGS. 2, 5, 6, 13 and 14, the override member 12 preferably has a first portion 12a operatively coupleable with the clutch member 7 and a second portion 12b operably engageable by the deadlatch 14 and the actuator 16, the second portion 12b being spaced vertically from (preferably below) the first portion 12a. Preferably, the override member 12 includes an elongated body 36 providing the override member first and second portions 12a, 12b, i.e., with the two portions 12a, 12b being integrally formed. However, the override member 12 may alternatively be formed of two or more separate portions connected or coupled in any appropriate manner (no alternatives shown). The override member body 36 has first and second ends 36a, 36b and a retention surface 38 disposed generally between the first and second ends 36a, 36b, the body 36 also providing the drive surface 26 (as discussed above) with the two surfaces 26, 38 being spaced apart and generally facing each other. The deadlatch 14 is contactable with the override member retention surface 38, so as prevent displacement of the override member 12 toward the operative position O_{P}, when the deadlatch 14 is located at the latching position d_{L}. In other words, the deadlatch 14 is positioned with respect to the override member 12 such that the latching arm 31 contacts/engages with the override member retention 38 at the latching position d_{L}.

Referring to FIGS. 2, 5, 6 and 18, as discussed above, the override member first portion 12a is operatively coupled with the clutch member 7 such that movement of the override member 12 between the inoperative and operative positions I_{P}, O_{P} displaces the clutch member 7 into engagement with at least one of the two spindles 4, 5. Preferably, the operative coupling of the override member 12 and the clutch member 7 is configured such that the clutch member 7 is displaceable when the override member 12 is disposed at the inoperative position I_{P}. As such, the clutch mechanism 6 is normally operable to couple and uncouple the two spindles 4, 5, and to thereby alternatively permit and prevent operation of the retractor 3 and movement of the latch 2, independently of the override mechanism 10.

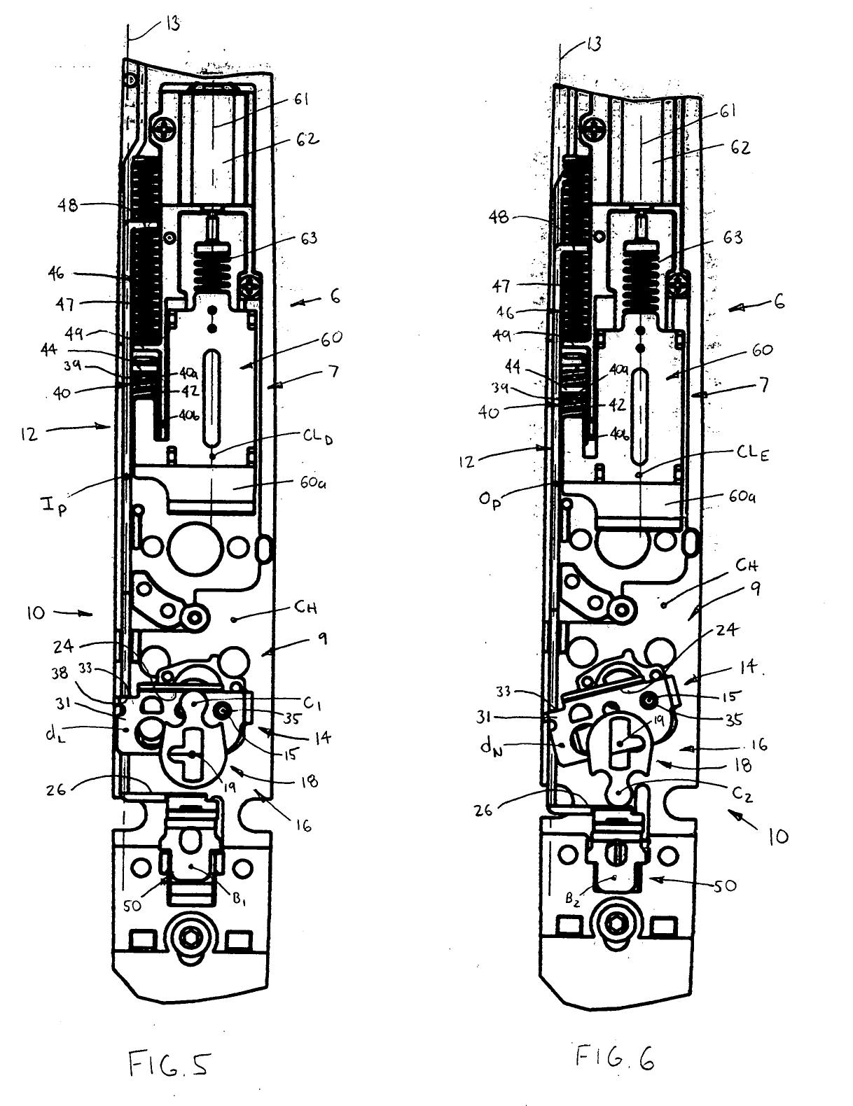

As best shown in FIGS. 5 and 6, in order to enable both the override member 12 to displace the clutch member 7 and to permit independent operation of the clutch mechanism 6, the override mechanism 10 preferably further comprises a coupler 40 for operatively coupling the override member 12 with the clutch member 7. The coupler 40 is configured to operatively connect the override member 12 with the clutch member 7 such that the coupler 36 pushes against and displaces the clutch member 7 into engagement with at least one of first and second spindles 4, 5 when the override member 12 displaces toward the operative position O_{P}. Further, the coupler 40 is configured such that the clutch member 7 is displaceable when the override member 12 is disposed, and remains, at the inoperative position I_{P}. Preferably, the coupler 40 has opposing first and second ends 40a, 40b, one end 40a or 40b being connected with either the override member 12 or the clutch member 7, respectively, and the other one of the two ends 40a, 40b being merely contactable (but unconnected) with the other one of the override member 12 and the clutch member 7. As such, movement of the override member 12 toward the operative position O_{P} causes the coupler 40 to push against and displace the clutch member 7 into engagement with one or both spindles 4, 5, while the clutch member 7 is permitted to displace as the override member 12 remains at the inoperative position I_{P}. Further, the coupler 40 is also preferably configured to at least partially bias the override member 12 toward the inoperative position I_{P}, as discussed below.

Most preferably, the override member body 36 further has a pusher surface 39 spaced from (and preferably above) the retention surface 38 and the coupler 40 includes a spring 42 extending between the override member pusher surface 39 and the clutch member 7. As such, when the preferred actuator cam 18 pushes against the override member drive surface 26 to displace the override member 12 toward the operative position O_{P}, such movement of the override member 12 causes the pusher surface 39 to displace the spring 42, thereby displacing the clutch member 7. Further, the override member body 36 preferably includes an integral pusher tab 44 providing the pusher surface 39 and one end 44a of the spring 42 is attached to the tab 44, the other end of the spring 42 being disposed or disposeable against the clutch member 7.

Furthermore, the override mechanism 10 preferably further comprises a return member 46 configured to bias the override member 12 toward the inoperative position I_{P}. The return member 46 preferably includes a spring 47 extending between the override member 12, most preferably a return tab 48 of the override body 36, and a stop member 49 of the lock assembly 1. As such, when the override member 12 displaces toward the operative position O_{P}, the spring 46 becomes compressed as the return tab 48 displaces toward the stop member 49. Thereafter, when the preferred actuator cam 18 disengages from the override member drive surface 26, the return spring 47 biases the return tab 48 generally away from the stop member 49, thereby displacing the override member 12 toward the inoperative position I_{P}.

Referring now to FIGS. 7-12, the lock assembly housing 8 preferably has a fastener access hole H and at least one fastener F for mounting the housing 8 to a base surface S (e.g., vertical surface of door D) or a component such as a battery cover CA (FIG. 2) within the housing 8, the access hole H permitting access to the fastener F. Also, the override mechanism 10 preferably further comprises at least one barrier 50 movably coupled with the override member 12, having a clearance hole 52, and being disposed within the lock housing 8. The barrier 50 is configured to extend across and obstruct the housing access hole H at a first position B₁ when the override member 12 is located at the inoperative position I_{P}, thereby preventing access to the fastener F and thus removal of the housing 8 from the base surface S or of the cover CA (or other component) from the housing 8. The barrier 50 is displaceable to a second position B₂ at which the clearance hole 52 aligns with the housing access hole H to permit access to the fastener F when the override member 12 is located at the operative position O_{P}. Preferably, the barrier 50 is formed as a generally L-shaped plate 54 connected with the second end 36b of the override member elongated body 36, the plate 54 having a generally horizontal section 54a attached to the body 30 and a generally vertical section 54b with a through-hole 55 providing the clearance hole 52. However, the barrier 50 may alternatively be formed in any other appropriate manner.

With the basic structure above, the override mechanism 10 of the present invention basically operates as follows. In ordinary use of the lock assembly 1, the override member 12 is disposed in the inoperative position O_{P}, permitting the electronic clutch mechanism 6 to operate independently of the override mechanism 10, with the deadlatch 14 being engaged with the override member 12. As such, any attempt to tamper with the lock assembly 1 by pulling the override member 12 toward the operative position O_{P}, thus displacing the clutch member 12 to couple the spindles 4, 5 so as to enable operation of the retractor 3, is prevented by the deadlatch 14. However, when it is desired to operate the override mechanism 12, for example, to enable unlocking of the lock assembly 1 in the event of a failure of the electronic clutch assembly 6, a user operates the actuator 16 to displace the override member 12 toward the operative position O_{P} to thereby couple the lock spindles 4, 5, and thus connect the handle H with the retractor 3, as discussed in further detail below. With the preferred cylinder lock 20 and connected cam 18, rotation of the cylinder 22 first disengages the cam 18 from the deadlatch 14, permitting displacement of the override member 12, and then pushes the override member 12 toward the operative position O_{P}. As the override member 12 displaces toward the operative position O_{P}, the barrier member(s) move to the access position B₂ to permit the fastener F to be accessible by authorized personnel.

Further, once the lock assembly 1 has been operated as desired, the preferred lock cylinder 22 is rotated back to the cylinder first position 1₁ to disengage the cam 18 from the override member drive surface 26. Once the cam 18 is disengaged, the preferred return spring 46 biases the override member 12 back to the inoperative position I_{P}, while the cam 18 contacts and then pushes the deadlatch 14 to the latching position d_{L}. The cam 18 continues to angularly displace until reaching the cam first position c₁, at which the cam 18 is disposed against the deadlatch retention surface 24 while the deadlatch 14 engages with the override member retention surface 32, thereby securing the override member 12 at the inoperative position I_{P}. The deadlatch 14 will thereafter prevent displacement of the override member 12 toward the operative position O_{P} so as to resist tampering with, and unauthorized operation of, the lock assembly 1.

Having described the basic elements above, these and other components of the deadlatchable override mechanism 10 of the present invention are described in greater detail below.

Referring to FIGS. 1, 2, 18 and 19, the deadlatchable override mechanism 10 is preferably used with a lock assembly 1 that is mountable to a door D and includes a latch 2 that is displaceable through a bore (not indicated) formed in the door D between an extended or locked position (see FIG. 1) and a retracted or unlocked position (not shown). In the extended/locked position, the latch 2 is engageable with a strike mounted within a door frame (neither shown) and in the retracted/unlocked position, the latch 2 is disposed within the door D (i.e., the bore, etc.) so that the door D is pivotable with respect to the door frame. Further, the retractor 3 (see FIG. 19) is configured to displace the latch 2 between the locked and unlocked positions, and the first or “inner” spindle 4 is operatively coupled with the retractor 4 such that rotation of the inner spindle 4 displaces the latch 2 between the locked and unlocked positions. Furthermore, the second or outer spindle 5 is configured to be manually rotatable about a spindle axis A_{S} by means of a handle H and is releasably connectable with the first, inner spindle 4 such that rotation of the second spindle 5, when coupled with the first spindle 4, operates the retractor 3.

As discussed above, the clutch member 7 is preferably configured to displace at least a portion of one of the first and second spindles 4, 5 into engagement with the other one of the first and second spindles 4, 5. More specifically, the movable member 7 is preferably constructed as a “movable wall” or cam 60 having a wedge-shaped front end 60a. The cam 60 is displaceable along a generally vertical axis 61 (which extends generally parallel to the override member axis 13) between disengaged and engaged positions CL_{D}, CL_{E} generally by means of a motor 62 with a rotatable shaft 63 or a solenoid (not shown), and alternatively by movement of the override member 12 between the inoperative and operative positions I_{P}, O_{P}. Further, the electronic clutch mechanism 6 further includes a generally conical clutch member 64 slidably coupled with one of the spindles 4, 5, preferably the inner spindle 4, and releasably connectable with the other one of the two spindles 4, 5, preferably the outer spindle 5. The cam 60 and conical clutch member 62 are configured such that displacement of the cam 62 toward the engaged position CL_{E} causes cam front end 60a to contact and push the clutch member 64 to displace into engagement with the outer spindle 5. Alternatively, movement of the cam 60 toward the disengaged position CL_{D} permits the clutch member 64 to displace out of engagement with the outer spindle 5.

Although the lock assembly 1 preferably includes the retractor 3, the inner and outer spindles 4, 5 and the electronic clutch mechanism 6 as described above and depicted in the drawings, the deadlatchable override mechanism 10 of the present invention may be used with any other appropriate door lock assembly or even other types of a lock assemblies (e.g., a safe lock) and the scope of the present invention is not limited to any specific lock assembly structure(s).

Referring to FIGS. 13 and 14, the elongated body 36 of the override member 12 is preferably formed as a generally vertically-extending, generally rectangular main bar portion 70 with upper and lower ends 70a, 70b and a generally horizontally-extending arm portion 72 extending from the main bar lower end 70b. The main bar portion 70 includes two vertically spaced, generally rectangular tabs 74, 76, the lower tab 74 providing the pusher tab 44 and the upper tab 76 providing the return tab 48, the two tabs 44, 48 each being described above. Further, the main bar portion 76 also includes a notch 78 defining the retention surface 38, the arm portion 31 of the deadlatch 14 being disposeable within the notch 78 so as to contact the retention surface 38. Furthermore, the horizontal arm portion 72 has an upper surface 72a providing the drive surface 26 and a front edge 72b to which is attached the barrier 50.

Referring now to FIGS. 15-17, the deadlatch body 30 is preferably generally clip-like and includes front and rear generally parallel plate sections 82, 84 connected by a generally perpendicular portion 86 integrally formed with side edges 82a, 84a of each plate 82, 84. The front plate section 82 includes a generally rectangular projection 85 extending outwardly from the plate upper edge 82b and having a lower surface 85a providing the deadlatch retainer surface 24 and a generally circular pivot hole 86 configured to receive a portion of the pivot shaft 35, as discussed above. Further, the front plate section 82 also has a notched section 83 with a generally horizontal edge section 88 providing the latching surface 33. Furthermore, the rear plate section 84 includes a central clearance hole 90 configured to receive a support hub 92 mounted to the housing base 9, and slotted clearance hole 94 through which extends the pivot shaft 35.

Although the override member 12 is preferably formed as a vertically-extending bar 70 with a horizontal arm portion 72 and the deadlatch is preferably formed as a generally clip-like body 30, either or both of the override member 12 and deadlatch 14 may alternatively be formed in any appropriate manner that permits the override mechanism 10 to function generally as described herein. For example, the override member 12 may extend substantially horizontally, be directly attached to the clutch member/cam 7, constructed to pivot instead of linearly displace, may include two or more connected components formed in any appropriate manner, etc. Further for example, the deadlatch 14 may be formed as a generally rectangular plate or as a generally circular or rectangular block, may be constructed to linearly displace between the latching and nonlatching positions, etc. The scope of the present invention includes these and all other appropriate constructions that enable the override mechanism 10 to function as generally described herein.

It will be appreciated by those skilled in the art that changes could be made to the embodiments or constructions described above without departing from the broad inventive concept thereof. It is understood, therefore, that this invention is not limited to the particular embodiments or constructions disclosed, but it is intended to cover modifications within the spirit and scope of the present invention as generally recited in the appended claims.

I claim:

1. An override mechanism for a lock assembly, the lock assembly including a movable latch, a retractor for displacing the latch, first and second rotatable spindles for operating the retractor, and an electronic clutch with a movable member for releasably connecting the first and second spindles, the override mechanism comprising:
an override member movable between an inoperative position and an operative position and configured to displace the clutch member so as to connect the first and second spindles when the override member displaces from the inoperative position toward the operative position; and
a deadlatch movable between a latching position and a nonlatching position and configured to releasably retain the override member at the inoperative position when the deadlatch is disposed at the latching position.

2. The override mechanism as recited in claim 1 further comprising an actuator configured to displace the override member between the inoperative and operative positions.

3. The override mechanism as recited in claim 2 wherein the actuator is further configured to releasably retain the deadlatch at the latching position.

4. The override mechanism as recited in claim 3 wherein the actuator includes a cam displaceable between first and second positions, the cam being configured to retain the deadlatch at the latching position when the cam is located at the cam first position and configured to displace the override member toward the override position when the cam displaces toward the second position.

5. The override mechanism as recited in claim 4 wherein the actuator further includes a lock with a rotatable cylinder, the cam being operably connected with the cylinder such that rotation of the cylinder displaces the cam between the cam first and second positions.

6. The override mechanism as recited in claim 4 wherein the deadlatch has a retention surface, the override member has a drive surface, the actuator cam is contactable with the retention surface so as to retain the deadlatch in the latching position when the cam is disposed at the cam first position, and the cam contacts and pushes against the override member drive surface when the cam displaces toward the cam second position.

7. The override mechanism as recited in claim 6 wherein the override member further has a retention surface spaced from and facing generally toward the drive surface, the deadlatch being contactable with the retention surface so as to prevent displacement of the override member toward the operative position when the deadlatch is located at the latching position.

8. The override mechanism as recited in claim 4 wherein the cam is rotatable about a cam axis between the cam first and second positions.

9. The override mechanism as recited in claim 8 wherein the deadlatch is rotatable about a deadlatch axis between the latching and nonlatching positions, the deadlatch axis being one of spaced from the cam axis and collinear with the cam axis.

10. The override mechanism as recited in claim 4 wherein the actuator is further configured to releasably retain the override member at the operative position when the cam is disposed at the cam second position.

11. The override mechanism as recited in claim 4 wherein the override member includes an elongated body having a retention surface and a drive surface, the deadlatch is contactable with the retainer surface so as to prevent displacement of the override member toward the operative position when the cam is engaged with the deadlatch, and the cam is contactable with the drive surface such that the cam pushes the override member toward the operative position as the cam displaces toward the cam second postion.

12. The override mechanism as recited in claim 2 wherein the actuator includes a lock with a rotatable cylinder, the cylinder being operatively connected with the override member such that rotation of the cylinder displaces the override member from the inoperative position toward the operative position.

13. The override mechanism as recited in claim 1 further comprising an actuator configured to releasably retain the deadlatch at the latching position and to alternatively displace the override member toward the operative position.

14. The override mechanism as recited in claim 1 wherein the override member has a first portion operatively coupleable with the clutch member and a second portion operably engageable by the deadlatch.

15. The override mechanism as recited in claim 14 wherein the override member includes an elongated body providing the override member first and second portions.

16. The override mechanism as recited in claim 14 wherein the override member body has first and second ends and a retention surface disposed generally between the first and second ends, the deadlatch being contactable with the retention surface so as prevent displacement of the override member toward the operative position.

17. The override mechanism as recited in claim 16 wherein the override member body further has a pusher surface and the override mechanism further includes a coupler extending between the override member pusher surface and the clutch member such that the coupler pushes against and displaces the clutch member when the override member displaces toward the operative position.

18. The override mechanism as recited in claim 16 wherein the override member body further has a drive surface and the override mechanism further comprises an actuator configured to engage with the override member drive surface so as to displace the override member between the inoperative and operative positions.

19. The override mechanism as recited in claim 15 wherein:
the lock assembly further includes a housing with an access hole and at least one fastener for mounting the housing to a surface, the access hole permitting access to the fastener; and
the override mechanism further includes a barrier movably coupled with the override member, having a clearance hole, and being disposed within the housing, the barrier extending across and obstructing the housing access hole when the override member is located at the operative position and the barrier being positioned such that the clearance hole aligns with the housing access hole to permit access to the fastener when the override member is located at the operative position.

20. The override mechanism as recited in claim 1 wherein the override member is operatively coupled with the clutch member such that movement of the override member between the inoperative and operative positions displaces the clutch member into engagement with at least one of the two spindles and the and the clutch member is displaceable when the override member is disposed at the inoperative position.

21. The override mechanism as recited in claim 1 wherein the override mechanism further includes a coupler configured to operatively connect the override member with the clutch member such that the coupler pushes against and displaces the clutch member into engagement with at least one of first and second spindles when the override member displaces toward the operative position.

22. The override mechanism as recited in claim 21 wherein the coupler is configured such that the clutch member is displaceable when the override member is disposed at the inoperative position.

23. The override mechanism as recited in claim 21 wherein the coupler includes a spring having opposing first and second ends, one of the first and second ends being connected with one of the override member and the clutch member and the other one of the first and second ends being contactable with the other one of the override member and the clutch member.

24. The override mechanism as recited in claim 21 wherein the coupler is configured to bias the override member toward the inoperative position.

25. The override mechanism as recited in claim 1 wherein the deadlatch includes a body rotatable between the latching and nonlatching positions, the body being configured to engage with the override member at the latching position.

26. The override mechanism as recited in claim 25 wherein:
the override mechanism further comprises an actuator configured to displace the override member between the inoperative and operative positions and alternatively configured to releasably retain the deadlatch at the latching position; and
the deadlatch body includes a latching surface contactable with the override member and a retention surface engageable by the actuator to retain the deadlatch at the latching position such that the deadlatch releasably retains the override member at the inoperative position when the actuator is engaged with the deadlatch retention surface and the latching surface is engaged with the override member.

27. The override mechanism as recited in claim 25 wherein the lock assembly further includes a housing with an interior chamber and a base wall partially bounding the chamber, the deadlatch body being rotatably mounted to the base wall so as to be disposed within the interior chamber.

28. The override mechanism as recited in claim 1 wherein the lock assembly further includes a housing with an interior chamber, the electronic clutch being disposed within the interior chamber, and the override member and deadlatch are movably disposed within the housing chamber.

29. An override mechanism for a lock assembly, the lock assembly including first and second spindles and an electronic clutch with a movable member for releasably connecting the first and second spindles, the override mechanism comprising:
an override member movable between an inoperative position and an override position and configured to displace the clutch member so as to connect the first and second spindles when the override member displaces from the inoperative position toward the override position;
a deadlatch movable between a latching position and a nonlatching position and configured to releasably retain the override member at the inoperative position when disposed at the latching position; and
an actuator configured to at least one of displace the override member between the inoperative and override positions and releasably retain the deadlatch at the latching position.

30. A lock assembly comprising:
a latch displaceable between locked and unlocked positions;
a retractor configured to displace the latch between the locked and unlocked positions;
a first spindle operatively coupled with the retractor such that rotation of the first spindle displaces the latch between the locked and unlocked position;
a second spindle configured to be manually rotatable and releasably connectable with the first spindle such that rotation of the second spindle when connected with the first spindle operates the retractor;
an electronic clutch including a movable member configured to displace at least a portion of one of the first and second spindles into engagement with the other one of the first and second spindles;
an override member movable between an inoperative position and an override position and configured to displace the clutch member so as to connect the first and second spindles when the override member displaces from the inoperative position toward the operative position;
a deadlatch movable between a latching position and a nonlatching position and configured to releasably retain the override member at the inoperative position when disposed at the latching position; and
an actuator configured to displace the override member between the inoperative and operative positions and to alternatively retain the deadlatch at the latching position.
